(19) United States
(12) Patent Application Publication
(10) Pub. No.: US 2021/0132583 A1
(43) Pub. Date: May 6, 2021

(54) MANAGEMENT PLATFORM FOR DIGITAL TWIN WORKSHOP FOR AUTOMATED ASSEMBLY OF CIRCUIT BREAKERS

(71) Applicant: Wenzhou University, Wenzhou (CN)

(72) Inventors: Liang Shu, Wenzhou (CN); Shasha Li, Wenzhou (CN); Yanfang Yang, Wenzhou (CN); Ziran Wu, Wenzhou (CN); Miao Yang, Wenzhou (CN); Jie Zhang, Wenzhou (CN); Wei Chen, Wenzhou (CN); Xu Zhang, Wenzhou (CN); Di Shan, Wenzhou (CN)

(21) Appl. No.: 16/992,103

(22) Filed: Aug. 13, 2020

(30) Foreign Application Priority Data
Nov. 2, 2019 (CN) 201911062325.1

(51) Int. Cl. G05B 19/4097

(52) U.S. Cl. CPC G05B 19/4097; G05B 2219/32339; G05B 2219/21157

(57) ABSTRACT

A management platform for a digital twin workshop for automated assembly of circuit breakers includes a physical workshop management unit, a twin virtual workshop management unit, a twin data center and a service management unit. The physical workshop management unit performs scene object analysis, sensor network configuration and operation response. The twin virtual workshop management unit builds a virtual geometric scene and controls data movement response. The twin data center stores twin data. The service management unit performs on-line communication and builds twin data while managing and monitoring the physical workshop management unit. The management platform implements intellectualized and visualized management of production factors, activity planning and production process of a physical workshop for automated assembly of circuit breakers, so as to achieve automation control, parameter visualization and real-time-state monitoring of the physical workshop.

### BACKGROUND OF THE INVENTION

### 1. Field of the Invention

The present invention relates to assembly of circuit breakers, and more particularly to a management platform for a digital twin workshop for automated assembly of circuit breakers.

### 2. Description of the Prior Art

Small circuit breakers are extensively used in industrial and civil terminal power distribution and use as an important component for ensuring safety of terminal power distribution and use systems with a huge annual yield of up to billions units. Due to limits of the production technology, manufacturers of low-voltage apparatuses in China usually fall far behind their foreign competitors in terms of workshop management, production efficiency and O&M.

While automation of assembly processes for miniature circuit breakers has been rolled out in China, most relevant manufacturers now suffers from low automation level and lack for digitalized workshop management means and a comprehensive digitalized management platform for managing production factors, production activities and production processes, leading to poor process visibility, low production rate, and high O&M costs. With the development of computer technology and digitalization, it is an emerging trend that the traditional breaker workshops are transformed in terms of production factor management, production process control and equipment O&M through digitalization.

Hence, there is a need fora management platform for a digital twin workshop for automated assembly of circuit breakers, which can perform real-time ongoing management and interactive operation on a real-world physical automated workshop of circuit breakers, so as to implement intellectualized and visualized management of production factors, workshop activities and production process of the workshop for automated assembly, and to implement automation control, parameter visualization and real-time-state monitoring of the physical workshop, thereby significantly improving production management, enhancing product quality, and reducing operational costs.

### SUMMARY OF THE INVENTION

The objective of the present invention is to provide a management platform for a digital twin workshop for automated assembly of circuit breakers, which can perform real-time ongoing management and interactive operation on a real-world physical automated workshop of circuit breakers, so as to implement intellectualized and visualized management of production factors, workshop activities and production process of the workshop for automated assembly and to implement automation control, parameter visualization and real-time-state monitoring of the physical workshop, thereby significantly improving production management, enhancing product quality and reducing operational costs.

To achieve the foregoing objective, one embodiment of the present invention provides a management platform for a digital twin workshop for automated assembly of circuit breakers, which comprises a physical workshop management unit, a circuit breaker assembly twin virtual workshop management unit, a twin data center and a service management unit;

the physical workshop management unit for performing scene analysis on objects in a real-world physical workshop for automated assembly to form model data required for building the twin virtual workshop management unit, using a sensor network to convert physical signals of the objects in the real-world physical workshop into electrical signals so as to implement data collection and transmission, and building parent-child nesting relationships among assembly machinery equipment in the real-world physical workshop according to assembly relationships among the assembly machinery equipment so as to form an operation response mechanism;

the twin virtual workshop management unit for performing real-time communication with the physical workshop management unit, receiving the model data output by the physical workshop management unit and data collected by the sensor network to build a virtual geometric scene, performing real-time synchronous reproduction of all assembly actions of the physical workshop management unit in the virtual geometric scene, and after receiving data from the service management unit, combining the data with the operation response mechanism of the physical workshop management unit so as to build a corresponding data operation response mechanism, thereby implementing movement control on the assembly machinery equipment in the virtual geometric scene;

the twin data center for storing the data from the physical workshop management unit, from the twin virtual workshop management unit and from the service management unit; and

the service management unit for performing on-line communication with the physical workshop management unit, the twin virtual workshop management unit and the twin data center, designing data structure, data operation and data constraint of twin data in the twin virtual workshop management unit, and implementing management and monitoring of the physical workshop management unit.

Wherein, the physical workshop management unit comprises:

a scene object analysis module, for performing the scene analysis on the objects in the real-world physical workshop to form the model data required for building the twin virtual workshop management unit;

a sensor setting module, for using the sensor network to convert the physical signals of the objects in the real-world physical workshop into the electrical signals to implement the data collection and transmission; and

an operation response mechanism forming module, for building the parent-child nesting relationships among the assembly machinery equipment in the real-world physical workshop according to the assembly relationships among the assembly machinery equipment so as to form the operation response mechanism.

Wherein, the objects in the real-world physical workshop include a sensor system for collecting information on production lines, assembly workers, a workshop physical environment, a PLC system, the assembly machinery equipment and a physical workshop facility.

Wherein, the twin virtual workshop management unit comprises:

a virtual geometric scene building module, for communicating with the physical workshop management unit in a real-time manner, receiving the model data output by the physical workshop management unit and the data collected by the sensor network to build the virtual geometric scene, and performing the real-time synchronous reproduction of all the assembly actions of the physical workshop management unit in the virtual geometric scene; and

a data operation response module, for combining the data with the operation response mechanism of the physical workshop management unit after receiving the data from the service management unit so as to build the corresponding data operation response mechanism, thereby implementing the movement control on the assembly machinery equipment in the virtual geometric scene.

Wherein, the data coming from the physical workshop management unit, the twin virtual workshop management unit and the service management unit, respectively and stored in the twin data center include state information data of automated component assembly, assembly line sensing data, workshop resource data, command data and operational state data of the assembly machinery equipment.

Wherein, the service management unit comprises:

a communication control module, for performing on-line communication with the physical workshop management unit, the twin virtual workshop management unit and the twin data center;

a data building module, for designing the data structure, the data operation and the data constraint of twin data in the twin virtual workshop management unit; and

a management and control module, for implementing management and monitoring of data generated in the real-world physical workshop and providing relevant decision-making service.

Wherein, the data structure of the twin data in the data building module forms a data structure tree, and defines nodes, branches, and trunks of the data and corresponding relevant parameters; and the data operation of the twin data in the data building module includes describing operational types and operational means in the data structure; while the data constraint of the twin data in the data building module includes syntax, correlation, conditioning and dependence of and among the data.

The following beneficial effects can be achieved through implementation of embodiments of the present invention:

The present invention uses digital twin technology to build a digitalized comprehensive management platform that can be used in a circuit breaker production workshop so as to perform twin modeling on the physical workshop through digitalization, while comprehensively using contents such as twin model driving, twin data management, and twin workshop service system development, to make the workshop for automated assembly and the twin workshop connected with each other, so that an operator can perform real-time ongoing management and interactive operation on a real-world physical automated workshop of circuit breakers, so as to implement intellectualized and visualized management of production factors, workshop activities and production process of the workshop for automated assembly, and to implement automation control, parameter visualization and real-time-state monitoring of the physical workshop through the digital twin workshop, thereby significantly improving production management, enhancing product quality, and reducing operational costs.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a system block diagram of a management platform for a digital twin workshop for automated assembly of circuit breakers according to one embodiment of the present invention;

FIG. 2 shows a schematic structure of a physical workshop management unit of FIG. 1;

FIG. 3 shows a schematic structure of a twin virtual workshop management unit of FIG. 1;

FIG. 4 shows a schematic structure of a service management unit of FIG.

FIG. 5 illustrates how a main assembly line in the digital twin workshop works by using the twin virtual workshop management unit of the management platform of the embodiment of the present invention; and

FIG. 6 is a flowchart showing steps for the main assembly line of FIG. 5 to build a digital twin workshop model.

### DETAILED DESCRIPTION OF THE. PREFERRED EMBODIMENTS

For further illustrating the means and functions by which the present invention achieves the certain objectives, the following description, in conjunction with the accompanying drawings and preferred embodiments, is set forth as below to illustrate the implement, structure, features and effects of the subject matter of the present invention.

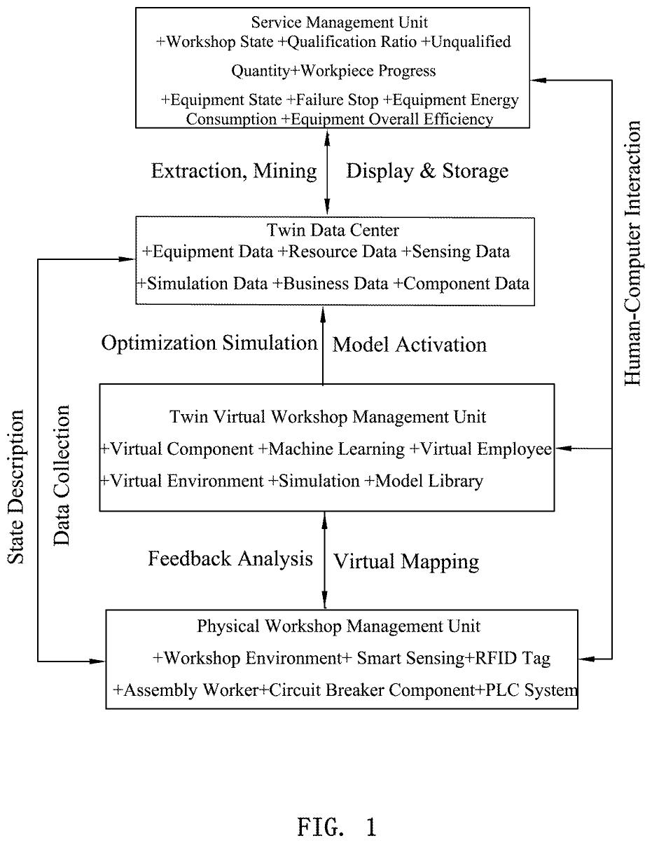

As shown in FIG. 1, a management platform for a digital twin workshop for automated assembly of circuit breakers according to one embodiment of the present invention comprises a physical workshop management unit, a circuit breaker assembly twin virtual workshop management unit, a twin data center and a service management unit. The physical workshop management unit performs scene analysis on objects in a real-world physical workshop for automated assembly to form model data required for building the twin virtual workshop management unit, and uses a sensor network to convert physical signals of the objects in the real-world physical workshop into electrical signals so as to implement data collection and transmission. It also builds parent-child nesting relationships among assembly machinery equipment in the real-world physical workshop according to assembly relationships among the assembly machinery equipment so as to form an operation response mechanism.

The twin virtual workshop management unit for performs real-time communication with the physical workshop management unit and receives the model data output by the physical workshop management unit and data collected by the sensor network to build a virtual geometric scene. It also performs real-time synchronous reproduction of all assembly actions of the physical workshop management unit in the virtual geometric scene, and after receiving data from the service management unit, combines the data with the operation response mechanism of the physical workshop management unit so as to build a corresponding data operation response mechanism, thereby implementing movement control on the assembly machinery equipment in the virtual geometric scene.

The twin data center stores the data from the physical workshop management unit, from the twin virtual workshop management unit and from the service management unit.

The service management unit performs on-line communication with the physical workshop management unit, the twin virtual workshop management unit and the twin data center, and designs data structure, data operation and data constraint of twin data in the twin virtual workshop management unit. It also implements management and monitoring of the physical workshop management unit.

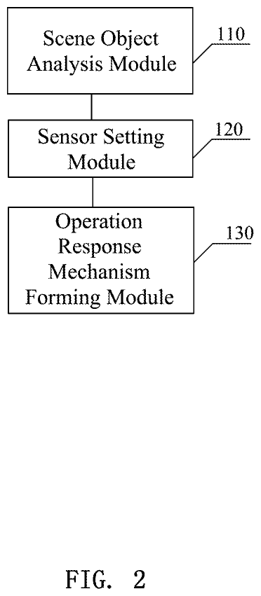

In the embodiment of the present invention, as shown in FIG. 2, the physical workshop management unit comprises the following components.

A scene object analysis module 110 performs the scene analysis on the objects in the real-world physical workshop to form the model data required for building the twin virtual workshop management unit.

A sensor setting module 120 uses the sensor network to convert the physical signals of the objects in the real-world physical workshop into the electrical signals to implement the data collection and transmission.

An operation response mechanism forming module 130 builds the parent-child nesting relationships among the assembly machinery equipment in the real-world physical workshop according to the assembly relationships among the assembly machinery equipment so as to form the operation response mechanism.

It is to be noted that in the physical workshop management unit when satisfying the requirements for basic assembly of circuit breakers can provide functions such as scene object analysis, sensor network configuration and operation response. Therefore, in the scene object analysis module 110, statistics, naming, grouping, tagging and other works are first performed for the objects in the real-world assembly production lines of circuit breakers (such as a sensor system for collecting information on production lines, assembly workers, a workshop physical environment, a PLC system, the assembly machinery equipment and a physical workshop facility), so that the virtual workshop management unit can build the virtual geometric scene and perform other subsequent works. In the sensor setting module 120, a sensor network is used to enable conversion of physical signals of the objects in the physical workshop to electrical signals, so as to serve twin data, twin virtual entities, and more. The research covers factors such as the type, the amount, the orientation and other factors of sensors, and enables building of the sensor network that implements data collection and transmission. In the operation response mechanism forming module 130, according to the assembly relationships among the assembly machinery equipment in the real-world physical workshop, parent-child nesting relationships between assembly bases and assembly claws of the assembly machinery equipment are established, thereby creating functions such as assembly object, assembly methods, assembly conditions, assembly contents and failure feedback to form operation response mechanism.

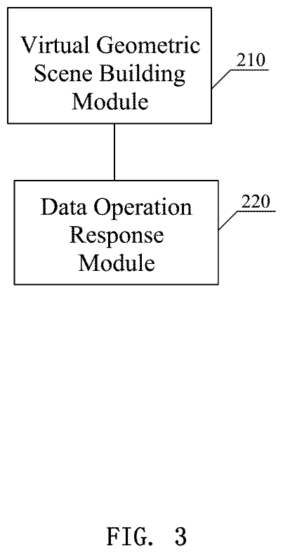

In the embodiment of the present invention, as shown in FIG. 3, the twin virtual workshop management unit comprises the following components.

A virtual geometric scene building module 210 communicates with the physical workshop management unit in a real-time manner, and receives the model data output by the physical workshop management unit and the data collected by the sensor network to build the virtual geometric scene. It also performs real-time synchronous reproduction of all the assembly actions of the physical workshop management unit in the virtual geometric scene.

A data operation response module 220 combines the data with the operation response mechanism of the physical workshop management unit after receiving the data from the service management unit so as to build the corresponding data operation response mechanism, thereby implementing the movement control on the assembly machinery equipment in the virtual geometric scene.

It is to be noted that the twin virtual workshop management unit is a mapping of the physical workshop entity in the virtual world, and is used to provide the real-world physical workshop with functions like visualization, workshop operational state monitoring, track collision detection, logic decision, and production scheduling simulation, thereby enabling activation control of the real-world workshop based on virtual mapping and twin data. Therefore, in the virtual geometric scene building module 210, model data are first formed for the factors of the objects in the scene object analysis module 110 such as naming, tagging and grouping, so as to build the virtual geometric scene. Afterward, all assembly actions of the physical workshop management unit are synchronously reproduced in the virtual geometric scene in a real-time manner by means of design of object modeling, sensor information, the operation response mechanism and other functional modules. In the data operation response module 220, through interface such as PLC and RFID, real-time communication with the physical workshop management unit is established, so as to develop a data operation response mechanism for the operation response mechanism coming from the physical workshop management unit and the data of the service management unit, thereby achieving the movement control over the assembly machinery equipment in the virtual workshop.

In the embodiment of the present invention, the twin data center stores the data coming from the physical workshop management unit, the twin virtual workshop management unit and the service management unit, respectively. The data includes state information data of automated component assembly, assembly line sensing data, workshop resource data, command data and operational state data of the assembly machinery equipment. The twin data center stores, analyzes and process the aforementioned data and then provides the processed data to the service management unit as decision-making information. These data include historical data and real-time data, and are used to activate positional and postural changes of circuit breakers with respect to the assembly machinery equipment in the virtual twin workshop. The changes are converted into images for continuous multi-level and multi-dimensional dynamic display in the three dimensional model of the workshop assembly line.

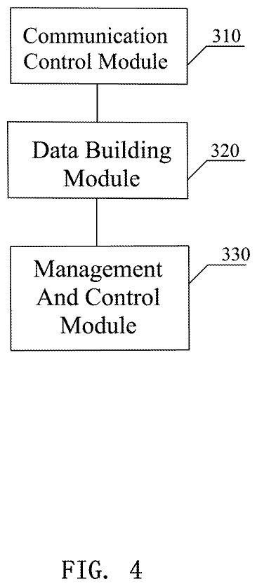

In the embodiment of the present invention, as shown in FIG. 4, the service management unit comprises: a communication control module 310, for performing on-line communication with the physical workshop management unit, the twin virtual workshop management unit and the twin data center; a data building module 320, for designing the data structure, the data operation and the data constraint of twin data in the twin virtual workshop management unit; and a management and control module 330, for implementing management and monitoring of data generated in the real-world physical workshop and providing relevant decision-making service.

It is to be noted that the service management unit, acting as the control interface of the digital twin workshop, can implement management and display of circuit breaker data orders, equipment geometric logic control, production management and information of individual assembly units, and monitoring and management of information about the workshop state, the unit qualification ratio, the unqualified quantity and the progress of workpiece assembly of the assembly production lines, thereby improving workshop operational management, enhancing production efficiency, and reducing corporate operational costs. Therefore, in the communication control module 310, since the physical workshop management unit, the twin virtual workshop management unit and the twin data center have to communicate with the relevant network components, it is necessary to select and build a proper twin data communication principle. This is achieved using TCP (Transmission Control Protocol) and building a communication module with contents such as servers, clients, IP addresses and port numbers. In the data building module 320, the twin data form the core of the entire physical information system, and thus design has to be done in terms of data structure, data operation and data constraint. Herein, a data structure tree is used as the data structure to define nodes, branches, and trunks of the data as well as their corresponding parameters. Data operations include describing operational types and operational means on the data structure, such as the read-write constraints of the data, and whether the data are public or private. Data constraints include syntax, correlation, conditioning and dependence among the data. In the management and control module 330, data generated in the real-world physical workshop are processed. These data include automated assembly production data, product qualification ratios, order fulfillment, equipment operational states, and production task scheduling. Also provided is the decision-making services related to equipment maintenance and production task planning.

In the embodiment of the present invention, building of a virtual workshop twin for a main assembly line of circuit breakers is described as an example for explaining the application of the virtual geometric scene building module 210 of the twin virtual workshop management unit in the management platform of the digital twin workshop for automated assembly and the application of the virtual workshop twin in the circuit breaker assembly service management unit. Specifically, as the first step, a virtual workshop twin is built.

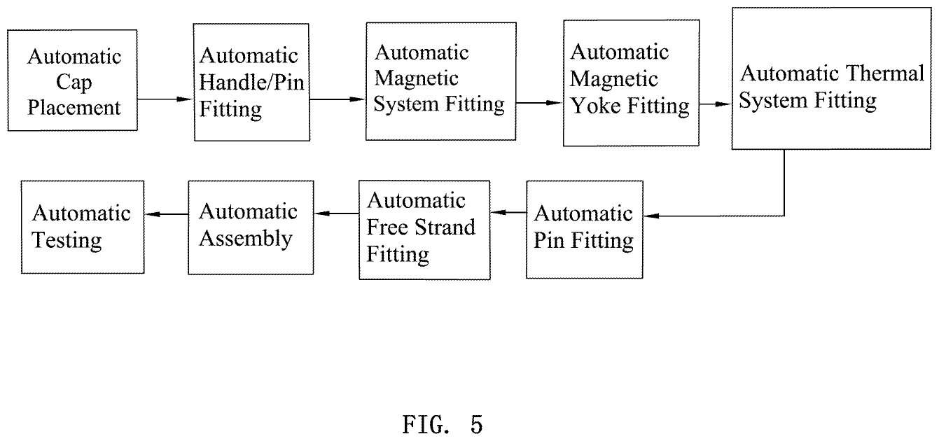

FIG. 5 illustrates how a main assembly line in the digital twin workshop for automated assembly using the twin virtual workshop management unit works. The automated assembly of circuit breakers follows a production line. The main assembly line includes nine production modules that serve for 13 basic production procedures, namely shell placement, handle/tension spring fitting, magnetic system fitting, magnetic yoke fitting, thermal system fitting, magnetic yoke fitting, five strand fitting, tripper fitting, large U fitting, small U fitting, arc-extinguishing chamber fitting, automatic test, and automatic enclosure. Each unit includes one or more part matching units. The part matching unit further includes plural part feeding units and assembling units. Wherein, the part matching units, the part feeding units and the assembling units are all mechanical assembly equipment belonging to the assembly production lines of circuit breakers.

The automated assembly production line uses two horizontally parallel tracks in the shell unit and the free strand unit, and uses two vertically parallel tracks in the other units. The subjects to be assembled are placed on vehicles that proceed along the tracks go through the entire assembly production line while receiving a series of assembly actions. The vehicles are then sent back by a vehicle return module to be reused in the tracks. Wherein, the return flow of the vehicles is divided into two parts that follow the upper and lower production line tracks, respectively. In the production line, components such as the handle/tension spring and the magnetic system are preliminarily assembled before fit into position. The material feeding and subsequent assembly operations are handled by the assembly machinery equipment automatically.

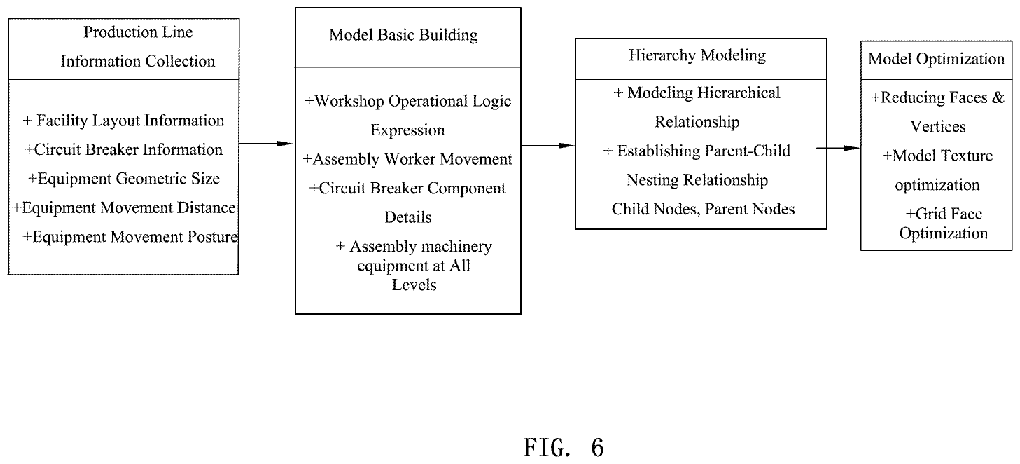

FIG. 6 shows steps to build a digital twin workshop model for automated assembly. First, information about the circuit breaker real-world assembly production lines is collected, including information about the layout of the real-world workshop, the geometric dimensions of the assembly machinery equipment for every production procedure, the physical structure relationships, the kinetic characteristics and movement postures of the equipment, as well as logic relationships of coordinated movements among assembly cylinders. Basic modeling is performed according to the collected information about the assembly production lines. Building of a digital twin geometric model of the assembly production line includes operational logic expression of the assembly machinery equipment in the workshop, manual assembly actions, details of circuit breaker components, automated guided vehicles (AGVs) and the assembly machinery equipment of all levels. A model object library is built for the virtual assembly workshop, so as to facilitate scheduling of the digital twin system of the virtual assembly workshop. Therefore, every digital twin model of the production workshop of circuit breakers is expressed as:

MDWS=MDequip∪MDprod∪MDpers∪MDenv,

where MDWS is the workshop digital twin model, MDequip is the assembly machinery equipment digital twin model, MDprod is the circuit breaker digital twin model, MDpers is the assembly worker digital twin model, MDenv is the environment twin model.

To analyze the digital twin geometric models of the circuit breaker assembly production lines built as described previously, the first thing to do is to model the hierarchical relationships of equipment according to hierarchy of the equipment. Each piece of the assembly machinery equipment is defined as an individual unity, and parent-child nesting relationships among the individual unites are identified by referring to the movement logic of the corresponding assembly machinery equipment. Through describing the postures of the sub-nodes in the parent-node coordinate system, locations and postures are combined sequentially, and expressed in the virtual assembly workshop as allocation of resources of the physical assembly workshop in the facility, thereby eventually building a virtual three-dimensional workshop scene. Since the circuit breaker itself and the assembly machinery equipment in the systems of different levels of the assembly line have numerous components and complicated textures that lead to more constraint relationships among components, the load imposed to the computer is particularly high. Therefore, the present invention optimizes the geometric model that build hierarchy in the model object library, thereby reducing the number of faces and the number of vertices, including model texture optimization and grid face optimization.

When the assembly machinery equipment of different levels assemble circuit breakers, according to dynamic movement postures of the real-world physical equipment and the behavioral relationships among equipment members, multi-level and multi-granularity parent-child nesting relationships are built among the models. By establishing certain shift relationships between parent nodes and child nodes, movement logic models of the assembly machinery equipment members of the assembly production line can be designed for implementing the corresponding mechanical movement rule constraints during automated assembly of circuit breakers, which correspond to the physical activities of the assembly production line, including the shape and locations of circuit breakers, the state of circuit breaker components, and movements of the assembly machinery equipment for assembling circuit breakers. In the assembly twin workshop, entering and exiting sites of circuit breakers are set, so as to enable activation of different assembly action commands. Meanwhile, the real-time data from the twin data center activate movements of the virtual assembly machinery equipment, including independent movements of assembly machinery equipment corresponding to every assembly procedure, and the coordinated movement relationships among equipment members. For example, the processing behavior, failure behavior, and coordination behavioral of assembly robot arms are used to implement high-fidelity activation of the assembly production line model, thereby building the digitalized model of the automated assembly virtual workshop.

The second step is about management and control of the virtual workshop twin.

In the service management unit, by means of bottom-layer block diagram interface, the interface of the real-time data display is divided into two parts. One part is for an always-on screen for displaying the workshop operational state, and the other part is for showing the unit assembly operational state and can be hidden through human-computer interaction. Wherein, the comprehensive workshop operational state is always shown in the interface, while abnormal workshop information (i.e. standby, pause, and failure) and unit assembly operational state are displayed through popups and red-light alerts. By using user-defined variables and system user-defiled wrapper function, information about the geometric size of the screen during operation of the virtual workshop, and by calculating the acquisition ratio and applying the ratio to the user-defined screen data, the user interface can adapt itself to the size of the screen.

By adding control codes to preset main camera components to allow change in monitoring angle, multi-angle three-dimensional real-time monitoring on the automated assembly production lines can be achieved. By using the button at the designated index in the function acquisition set, interaction with the digital twin workshop can be realized by means of a mouse and a keyboard, so when a user presses W, S, A, and D on the keyboard, the cursor can be moved forward, backward, leftward and rightward in the system scene. Pressing the Esc button on the keyboard leads to exit from the system. Pressing the space button and the Ctrl button on the keyboard can move the view angle up and down. Rolling the scroll wheel on the mouse can zoom in or out the displayed image. Right clicking the mouse rotates the view. Left clicking the mouse can add a box to the assembly line for collision testing, thereby selecting the box for which the workstation state is monitored in a real-time manner. A user is allowed to conduct interactive operations according to his/her needs.

Collision test boxes are added to the assembly production line model and highlighted at their edges. When the virtual equipment in the twin workshop is in different operational states, the operational states of the real-world physical equipment are displayed through different signals. When the signal state of the equipment is normal, the corresponding box is highlighted with blue. When the signal state of the equipment is pause or standby, the corresponding boxes are highlighted with yellow. When the signal state of the equipment is failure, the corresponding boxes are highlighted with red. After the digital twin workshop for automated assembly is put into operation, the real-world automated assembly production line collects information through its sensor network, and the workshop information is sent to the twin data center for information value-adding processing. The information is then analyzed and transmitted to the digital twin workshop service system. The workshop service system further processes information of the signal read by the twin data system so as to get information about the assembly progress, assembly indicators, the circuit breaker state and unit failure signals. When the signal of the equipment is normal, the twin assembly production line continuously works, and the signal lights atop the boxes are constant blue. At this time, a user can blue-highlight a certain box by left clicking the mouse. Meanwhile, the operation state information of the unit corresponding to the box is displayed, including the unit state, the production progress, the product qualification ratio and the number of unqualified products. During this operation, the system operation screen is not affected. To do this, a positioning camera in an off state is placed in front of every box, for the main camera of the system to position. By adding a control movement code to the main camera, displacement of the camera in the coordinate system can be controlled.

When some unit in the system receives an abnormal signal (i.e. standby, pause, or failure), activation toward the equipment of that unit stops, and the system changes the parameters corresponding to the attributes of the main camera, such as its orientation and view angle to make the main camera aim at the positioning camera in front of the corresponding box, so that the view angle is automatically switched to the failed unit, thereby achieving accurate positioning. At the same time, the corresponding boxes are highlighted at their edges, until the failure signal stops and the highlight at the edges vanishes. Such a failure positioning operation helps workshop management staff to timely identify and address problems about O&M, equipment examination and repair and state detection of the automated assembly production lines, thereby improving workshop management efficiency.

When the digital twin workshop for automated assembly receives no input from the operator, the system roams around all the assembly units of the entire twin workshop from the view angle of the operator in a screensaver-like browsing screen. Herein, the three-dimensional roaming is implemented as follows. When the digital twin workshop for automated assembly has not been operated by a user for 120 seconds, the system automatically enters the roaming state. In the roaming state, the lens moves along a predetermined, fixed path and view angle so that the lens first provides the panorama of the digital twin workshop for automated assembly, and then focuses on individual virtual assembly equipment by closing up to the assemblies units one by one and looping until the user operates the twin workshop and makes the system exit from the roaming state. During the roaming, if any failure or abnormal operation happens, the screen is automatically switched to the failed unit, until the unit becomes normal again.

To provide rotational display of the individual assembly units, the system is designed with ten close-up scenes, wherein the first scene is configured as the view of the entire virtual assembly production line, while the other scenes are all taken from the front of the individual boxes to show the detailed assembly actions carried out in the corresponding boxes. All the clos-up screens are dragged into the same group. When the system roaming mode is on, the object display function is used to turn off the main camera of the system, and then the addition function and the object display function are used to turn on the unit close-up scenes in the group successively and to loop the scenes. When the system roaming mode is off, the main camera is turned on, and all the close-up scenes in the group are closed.

Through the foregoing steps, a digital twin workshop for automated assembly of miniature circuit breakers can be built. To address the development need of automated assembly production line workshops of circuit breakers, the present invention analyzes the relationship between an automated assembly production workshop of circuit breakers and a digital twin workshop so as to design a method based on the digital twin technology for digital twin workshops for automated assembly of miniature circuit breakers. The method enables reproduction of the real-world movement logic of the equipment units for automated assembly of circuit breakers in a real-time, virtual manner. By using a mouse, a keyboard and/or a touch screen, human-computer interaction between a user and the digital twin workshop can be realized so that the user can directly, intuitively monitor the operational states of the real-world workshop and its equipment as well as the production progress. When the twin workshop has not been operated for a predetermined time, the system enters its three-dimensional roaming state automatically to display the operational state of the real-world physical workshop in a dynamic, real-time manner. The present invention uses the foregoing steps and method to ease the difficult in operational management and control of automated assembly of circuit breakers due to the numerous and complicated procedures, thereby enhancing transparency of workshop operation, ensuring real-time, visible and interactive operation of an automated assembly production workshop of circuit breakers, so as to further enhance operation and management of the workshop.

By implementing the present invention embodiment, the following beneficial effects can be achieved.

The present invention uses digital twin technology to build a digitalized comprehensive management platform that can be used in a circuit breaker production workshop so as to perform twin modeling on the physical workshop through digitalization, while comprehensively using contents such as twin model driving, twin data management, and twin workshop service system development, to make the workshop for automated assembly and the twin workshop connected with each other, so that an operator can perform real-time ongoing management and interactive operation on a real-world physical automated workshop of circuit breakers, so as to implement intellectualized and visualized management of production factors, workshop activities and production process of the workshop for automated assembly, and to implement automation control, parameter visualization and real-time-state monitoring of the physical workshop through the digital twin workshop, thereby significantly improving production management, enhancing product quality, and reducing operational costs.

It is to be noted that the units recited in the foregoing embodiment are divided according to functional logics, but the present invention is not limited to the described division as long as the relevant functions can be achieved. In addition, the names of the functional units are only for convenient distinction and shall not limit the scope of the present invention.

It is appreciated by people of ordinary skill in the art that the method described in the foregoing embodiment may be partially or entirely implemented by using a program to command related hardware, and the program may be stored in a computer-readable storage medium. The storage medium may be a ROM/RAM, a disk or a disc.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A management platform for a digital twin workshop for automated assembly of circuit breakers, comprising a physical workshop management unit, a twin virtual workshop management unit, a twin data center and a service management unit;
the physical workshop management unit for performing scene analysis on objects in a real-world physical workshop for automated assembly to form model data required for building the twin virtual workshop management unit, using a sensor network to convert physical signals of the objects in the real-world physical workshop into electrical signals so as to implement data collection and transmission, and building parent-child nesting relationships among assembly machinery equipment in the real-world physical workshop according to assembly relationships among the assembly machinery equipment so as to form an operation response mechanism;
the twin virtual workshop management unit for performing real-time communication with the physical workshop management unit, receiving the model data output by the physical workshop management unit and data collected by the sensor network to build a virtual geometric scene, performing real-time synchronous reproduction of all assembly actions of the physical workshop management unit in the virtual geometric scene, and after receiving data from the service management unit, combining the data with the operation response mechanism of the physical workshop management unit so as to build a corresponding data operation response mechanism, thereby implementing movement control on the assembly machinery equipment in the virtual geometric scene;
the twin data center for storing the data from the physical workshop management unit, from the twin virtual workshop management unit and from the service management unit; and
the service management unit for performing on-line communication with the physical workshop management unit, the twin virtual workshop management unit and the twin data center, designing data structure, data operation and data constraint of twin data in the twin virtual workshop management unit, and implementing management and monitoring of the physical workshop management unit.

2. The management platform of claim 1, wherein the physical workshop management unit comprises:
a scene object analysis module, for performing the scene analysis on the objects in the real-world physical workshop to form the model data required for building the twin virtual workshop management unit;
a sensor setting module, for using the sensor network to convert the physical signals of the objects in the real-world physical workshop into the electrical signals to implement the data collection and transmission; and
an operation response mechanism forming module, for building the parent-child nesting relationships among the assembly machinery equipment in the real-world physical workshop according to the assembly relationships among the assembly machinery equipment so as to form the operation response mechanism.

3. The management platform of claim 2, wherein the objects in the real-world physical workshop include a sensor system for collecting information on production lines, assembly workers, a workshop physical environment, a PLC system, the assembly machinery equipment and a physical workshop facility.

4. The management platform of claim 1, wherein the twin virtual workshop management unit comprises:
a virtual geometric scene building module, for communicating with the physical workshop management unit in a real-time manner, receiving the model data output by the physical workshop management unit and the data collected by the sensor network to build the virtual geometric scene, and performing the real-time synchronous reproduction of all the assembly actions of the physical workshop management unit in the virtual geometric scene; and
a data operation response module, for combining the data with the operation response mechanism of the physical workshop management unit after receiving the data from the service management unit so as to build the corresponding data operation response mechanism, thereby implementing the movement control on the assembly machinery equipment in the virtual geometric scene.

5. The management platform of claim 1, wherein the data coming from the physical workshop management unit, the twin virtual workshop management unit and the service management unit, respectively and stored in the twin data center include state information data of automated component assembly, assembly line sensing data, workshop resource data, command data and operational state data of the assembly machinery equipment.

6. The management platform of claim 1, wherein the service management unit comprises:
a communication control module, for performing the on-line communication with the physical workshop management unit, the twin virtual workshop management unit and the twin data center;
a data building module, for designing the data structure, the data operation and the data constraint of the twin data in the twin virtual workshop management unit; and
a management and control module, for implementing management and monitoring of data generated in the real-world physical workshop and providing relevant decision-making service.

7. The management platform of claim 6, wherein the data structure of the twin data in the data building module forms a data structure tree, and defines nodes, branches, and trunks of the data and corresponding relevant parameters; and the data operation of the twin data in the data building module includes describing operational types and operational means in the data structure; while the data constraint of the twin data in the data building module includes syntax, correlation, conditioning and dependence of and among the data.
